(19) United States
(12) Patent Application Publication
(10) Pub. No.: US 2006/0282740 A1
(43) Pub. Date: Dec. 14, 2006

(54) Method, apparatus and computer program providing multi-carrier acknowledgment channel

(75) Inventors: Jian Gu, Huangqi Nanhai (CN); Yuan-Joshua Zhu, Beijing (CN)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/429,042

(22) Filed: May 4, 2006

Related U.S. Application Data
(60) Provisional application No. 60/678,436, filed on May 6, 2005.

(51) Int. Cl. H04L 1/18

(52) U.S. Cl. 714/749

(57) ABSTRACT

A method includes generating a plurality of ACK channels, spreading each of the plurality of ACK channels with a separate one of a plurality of Walsh cover codes, combining each of the plurality of ACK channels, and applying a Walsh cover code to the combined plurality of ACK channels.

### CROSS REFERENCE TO RELATED APPLICATION

This Application claims the benefit under 35 USC 119(e) of U.S. Provisional Application No. 60/678,436 filed May 6, 2005.

### TECHNICAL FIELD

The exemplary embodiments of this invention relate generally to wireless digital communications systems and, more specifically, relate to multi-carrier wireless digital communications systems.

### BACKGROUND

The following abbreviations, at least some of which appear in the description below, are defined as follows:

3GPP2 Third Generation Partnership Project

ACK Acknowledgement

ARQ Automatic Repeat Request

BTS Base Transceiver Station

CDM Code Division Multiplex

CDMA Code Division Multiple Access

DL Downlink

DPCH Dedicated Physical Channel

F-DPCH Fractional Dedicated Physical Channel

FL Forward Link

HRPD High Rate Packet Data

MAC Medium Access Control

RLC Radio Link Control

RNC Radio Network Controller

RNTI Radio Network Temporary Identifier

TDM Time Division Multiplexed

UE User Equipment

UL Uplink

UMTS Universal Mobile Telecommunications System C304

UTRA-FDD UMTS Terrestrial Radio Access-Frequency Division Duplex

UTRAN UMTS Terrestrial Radio Access Network

WCDMA Wideband Code Division Multiple Access

A multiple radio frequency (RF) carrier (Multi-Carrier) system has been proposed to enhance code division multiple access system performance in 3GPP2. In general, Multi-Carrier systems have complex forward link (Base station to user equipment) and reverse link (user equipment to base station) deployments. The forward link and reverse link may be symmetrical or asymmetrical, depending on the application requirements for a given deployment.

It is known to multiplex two acknowledgment (ACK) feedback channels in a reverse link. However, in order to support N (N>2) ACK feedback channels, multiple reverse links, as well as multiple reverse link carriers, are required. The reverse carrier link allocation depends on traffic on the reverse link. For asymmetric traffic (for example, File Transfer Protocol (FTP)), the need to provide multiple reverse link carriers that correspond to the required multiple forward link carriers needed to support the forward link traffic is wasteful of the reverse link resource.

Further, carrier reallocation may be fast and adaptive in multi-carrier systems. The dynamic nature of carrier allocation can complicate the provision of the ACK feedback. At the same, the backwards compatibility of the conventional approach with 1× EV-DO is not maintained. The CDMA 2000 1× EV-DO (Evolution Data Optimized) is a packet data system that offers high speed data rates (of up to 2.4 Mbps) on wireless networks, and is designed to deliver several times the capacity of 1× at similar data rates.

A description of the current ACK feedback mechanism in EV-DO revision A can be found in the specification 3GPP C.S0024-A, version 1.0, March 2004, “cdma2000 High Rate Packet Data Air Interface Specification” in FIGS. 14.2.1.3.1-2 and 14.2.1.3.1-6 (pgs. 14-15, 14-19, and in the description in sub-paragraph 14.2.1.3.3.5, “ACK Channel”, at pgs. 14-31 and 14-32). FIGS. 1 and 2 herein correspond, respectively, to the FIGS. 14.2.1.3.1-2 and 14.2.1.3.1-6 of the 3GPP C.S0024-A specification. Note in FIG. 1 that the ACK Channel is defined to have one bit per slot, and with symbol repetition there are 32 binary symbols per half slot. The connector labeled ‘D’ in FIG. 1 connects to the connector labeled ‘D’ in FIG. 2, and shows the ACK channel being applied to through a Time Division Multiplexer (TDM) to a summing junction prior to a quadrature spreading block.

As is stated in paragraph 14.2.1.3.3.5, the ACK channel is used by an access terminal to inform the access network whether a physical layer packet addressed to the access terminal, and transmitted on the Forward Traffic Channel, has been successfully received. The access terminal transmits an ACK channel bit in response to every Forward Traffic Channel slot that is associated with a detectable preamble directed to the access terminal. The access terminal is specified to transmit at most one redundant positive ACK in response to a Forward Traffic Channel slot that is detected as a continuation of the physical layer packet that has been successfully received. Otherwise, the ACK channel is gated off.

When acknowledging a Single User packet, the ACK channel uses BPSK (bipolar keying) modulation, with a 1 representing positive acknowledgment and a −1 representing negative acknowledgment. When acknowledging a Multi-User packet the ACK channel uses OOK (ON-OFF keying) modulation, with a 1 (ON) representing positive acknowledgment and a 0 (OFF) representing negative acknowledgment. The access terminal transmits a positive acknowledgment on the ACK channel if it successfully receives a packet addressed to it on the Forward Traffic Channel, otherwise it transmits a negative acknowledgment. A Forward Traffic Channel packet is considered to be successfully received if it has a valid FCS.

A prior proposal for the ACK feedback mechanism for multi-carrier DO can be found in C00AIE-20050310-027, 3GPP2 Air Interface Evolution Technical Expert Meeting, Denver Co., Mar. 10-11, 2005. Page 16 of this document shows a diagram, reproduced as FIG. 3 herein, for asymmetric forward and reverse link assignment for a Multi-Carrier ACK. For the Multi-Carrier ACK it was proposed to provide time division multiplexed (TDM) ACK channel transmission for forward link carriers, with per carrier ACK channel transmission reduced to one quarter slot (one half slot in DO). The Medium Access Control (MAC) layer provides the ACK to the forward link association based on ACK transmit time.

Another prior proposal can be found in C30-20040518-016, “Reverse Link ACK for Multi-Carrier HRPD”, 18 Apr. 2005. This proposal discusses asymmetric operations between forward and reverse links (with more active FL channels than RL channels), where a common configuration is to have multiple FL channels with a single RL channel.

With regard to a proposed Multi-Carrier ACK channel, it is stated that the effectiveness of asymmetric operation depends heavily on the ability of the Base Station (BS) to communicate MAC layer information such as ACK/NAK, DRC, etc. between the multiple FL channels, and characterizes the above-described earlier proposal as suggesting a configuration in which two FL channels communicate directly without higher layer intervention. In effect, while the TDM approach for ACK/NAK and DRC is recommended, it is asserted that the earlier proposal has significant disadvantages when the number of FLs is increased beyond two.

The proposal found in C30-20040518-016 is said to overcome these limitations by adopting a Code Division Multiplex (CDM) approach, which is said to be more appropriate for Multi-Carrier operations for the following reasons.

The proposed CDM approach is said to be backward compatible with 1× DO (considered as a special case of MC HRPD with a single Walsh Index 0), and is said to allow support of more than two FLs with a single RL. This proposal states that while simultaneous support of 15 channels might not be realistic with a single RL, the CDM approach is said to allow uniform power distribution regardless of the number of FLs supported. Further, it is said that even if the number of FLs is limited to two, the CDM approach allows dynamical selection of data sources among the 15 pre-allocated frequency channels and associated ACK/NAK, without additional upper layer signaling.

The HRPD Rev0 transmits ACK/NAK using BPSK over half a slot (1024 chips) using Walsh channel W⁸₄ (with 128 repetitions), while the RevA uses W³²₁₂ (with 32 repetitions).

In the proposed CDM approach over the existing RACK Walsh channel, to accommodate up to 15 carriers, each of the channels is associated with a length 16 Walsh code, and the number of repetitions is reduced to eight for HRPD-Rev0, and to two for HRPD-RevA.

In addition, the following recommendations were made:
the use of sequence repetition instead of bit repetition;
the FL/RL pair is always assigned to Walsh 0, while the remainder of the FL channels are implicitly assigned Walsh codes based on the relative index to the paired FL/RL; and
reordering of the Walsh code numbers based on a Walsh tree to simplify migration from existing designs. For example, it is suggested to use Walsh 0 and Walsh 8 for the two carrier case, and Walsh 0 for the single carrier case.

FIG. 4 shows the proposal for the reverse link ACK Channel for the Multi-Carrier HRPD system, which reproduces FIG. 1 of the C30-20040518-016 proposal.

### SUMMARY OF THE INVENTION

The foregoing and other problems are overcome, and other advantages are realized, in accordance with the exemplary embodiments of these teachings.

In accordance with an exemplary embodiment of the invention, a method includes generating a plurality of ACK channels, spreading each of the plurality of ACK channels with a separate one of a plurality of Walsh cover codes, combining each of the plurality of ACK channels, and applying a Walsh cover code to the combined plurality of ACK channels.

In accordance with another exemplary embodiment of the invention, a method includes establishing a plurality of ACK channels each corresponding to a separate forward link channel, individually signal mapping and repeating the plurality of ACK channels, spreading each of the plurality of ACK channels with a separate one of a plurality of Walsh cover codes, combining each of the plurality of ACK channels, and applying a Walsh cover code to the combined plurality of ACK channels.

In accordance with another exemplary embodiment of the invention, a mobile terminal includes a transceiver, a processor coupled to the transceiver, and a memory coupled to the processor for storing a set of instructions, executable by the processor, for establishing a plurality of ACK channels each corresponding to a separate forward link channel, individually signal mapping and repeating the plurality of ACK channels, spreading each of the plurality of ACK channels with a separate one of a plurality of Walsh cover codes, combining each of the plurality of ACK channels, and applying a Walsh cover code to the combined plurality of ACK channels.

In accordance with another exemplary embodiment of the invention, a program of machine-readable instructions, tangibly embodied on an information bearing medium and executable by a digital data processor, performs actions including individually signal mapping and repeating a plurality of ACK channels, spreading each of the plurality of ACK channels with a separate one of a plurality of Walsh cover codes, combining each of the plurality of ACK channels, and applying a Walsh cover code to the combined plurality of ACK channels.

In accordance with another exemplary embodiment of the invention, a network element includes a wireless transceiver, a processor coupled to the wireless transceiver, and a memory coupled to the processor for storing a set of instructions, executable by the processor, for establishing a plurality of ACK channels each corresponding to a separate forward link channel, individually signal mapping and repeating the plurality of ACK channels, spreading each of the plurality of ACK channels with a separate one of a plurality of Walsh cover codes, combining each of the plurality of ACK channels, and applying a Walsh cover code to the combined plurality of ACK channels.

In accordance with another exemplary embodiment of the invention, a device includes an element for individually signal mapping and repeating a plurality of ACK channels, an element for spreading each of said plurality of ACK channels with a separate one of a plurality of Walsh cover codes, an element for combining each of said plurality of ACK channels, and an element for applying a Walsh cover code to said combined plurality of ACK channels.

In accordance with another exemplary embodiment of the invention, an integrated circuit includes an element for individually signal mapping and repeating a plurality of ACK channels, an element for spreading each of said plurality of ACK channels with a separate one of a plurality of Walsh cover codes, an element for combining each of said plurality of ACK channels, and an element for applying a Walsh cover code to said combined plurality of ACK channels.

### BRIEF DESCRIPTION OF THE DRAWINGS

The foregoing and other aspects of the exemplary embodiments of this invention are made more evident in the following Detailed Description, when read in conjunction with the attached Drawing Figure, wherein:

FIGS. 1 and 2 illustrate a current ACK feedback mechanism as defined in EV-DO revision A.

FIG. 3 is an illustration of a proposal for the ACK feedback mechanism for multi-carrier DO for asymmetric forward and reverse link assignment for a Multi-Carrier ACK.

FIG. 4 is a proposed reverse link ACK Channel for a Multi-Carrier HRPD system.

FIG. 5 illustrates an exemplary embodiment of a block diagram of a channel structure for ACK feedback in a Nx EV-DO system in accordance with the invention.

FIG. 6 shows user equipment (UE) that is constructed to include the reverse ACK channel functionality shown in FIGS. 5 and 7 when receiving multiple forward link carriers from a BS.

FIG. 7 illustrates another exemplary embodiment of a block diagram of a channel structure for ACK feedback in a Nx EV-DO system in accordance with the invention.

FIG. 8 illustrates a flow chart of an exemplary embodiment of the invention.

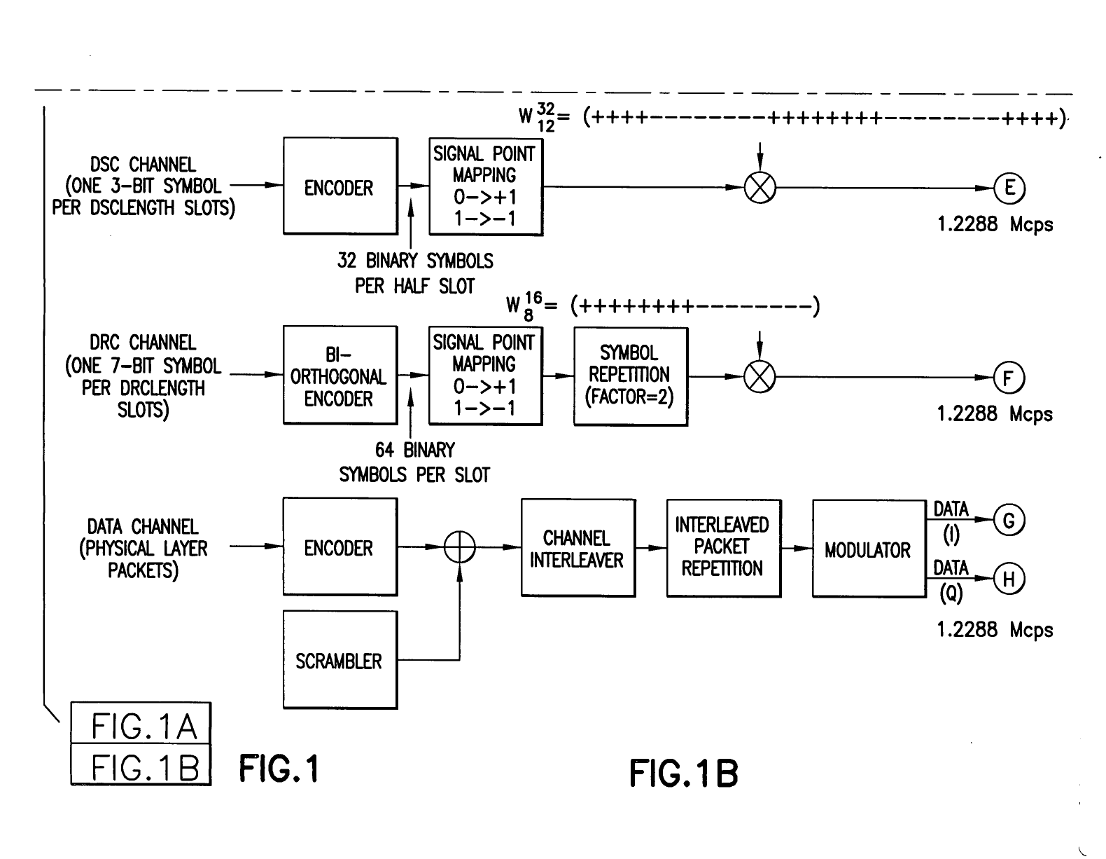

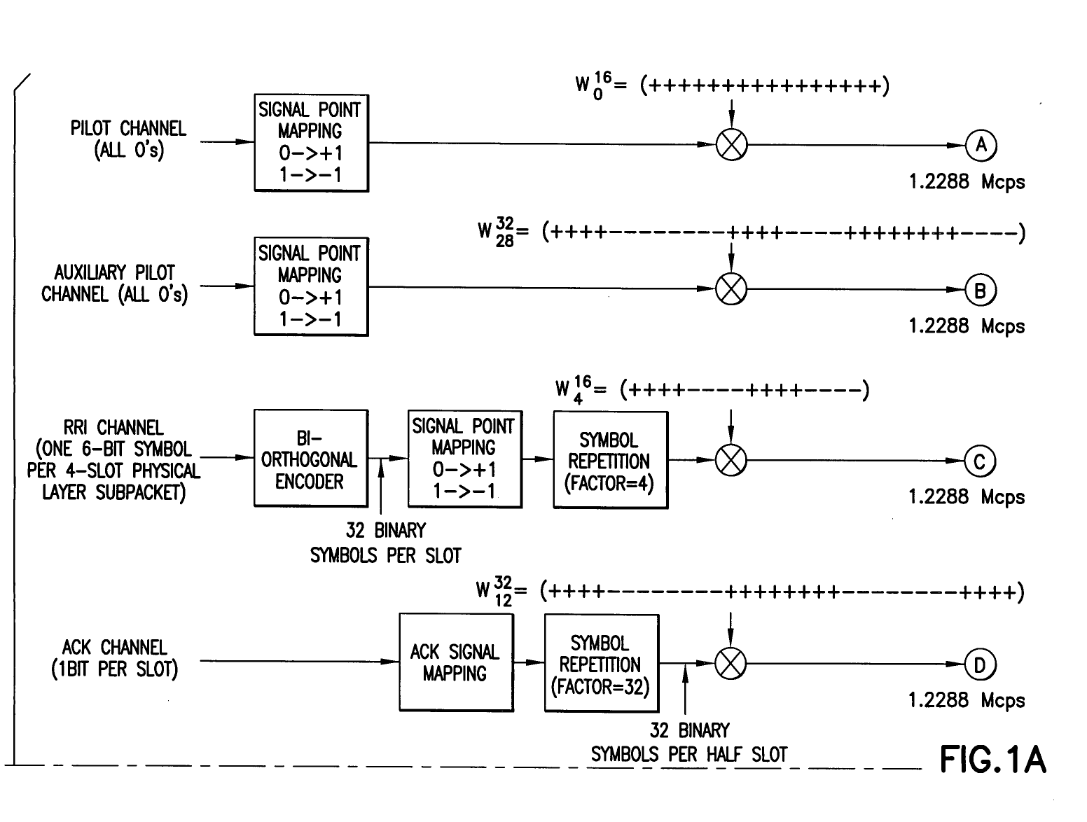

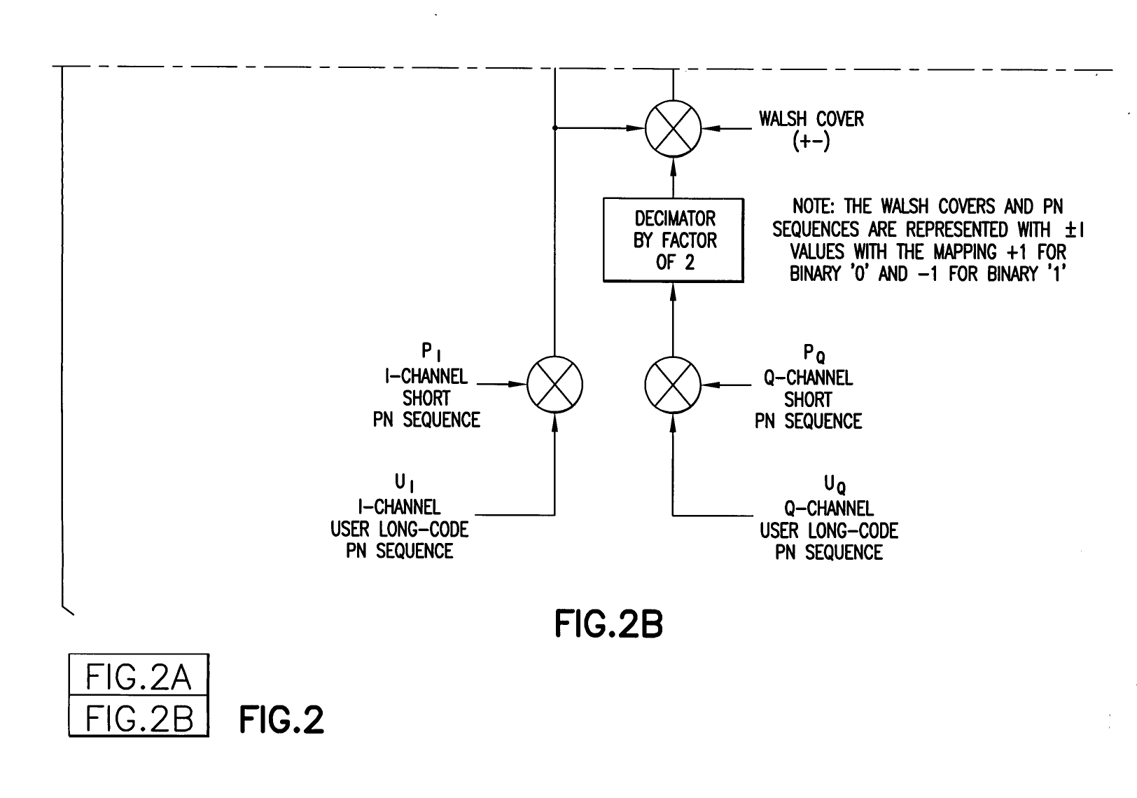

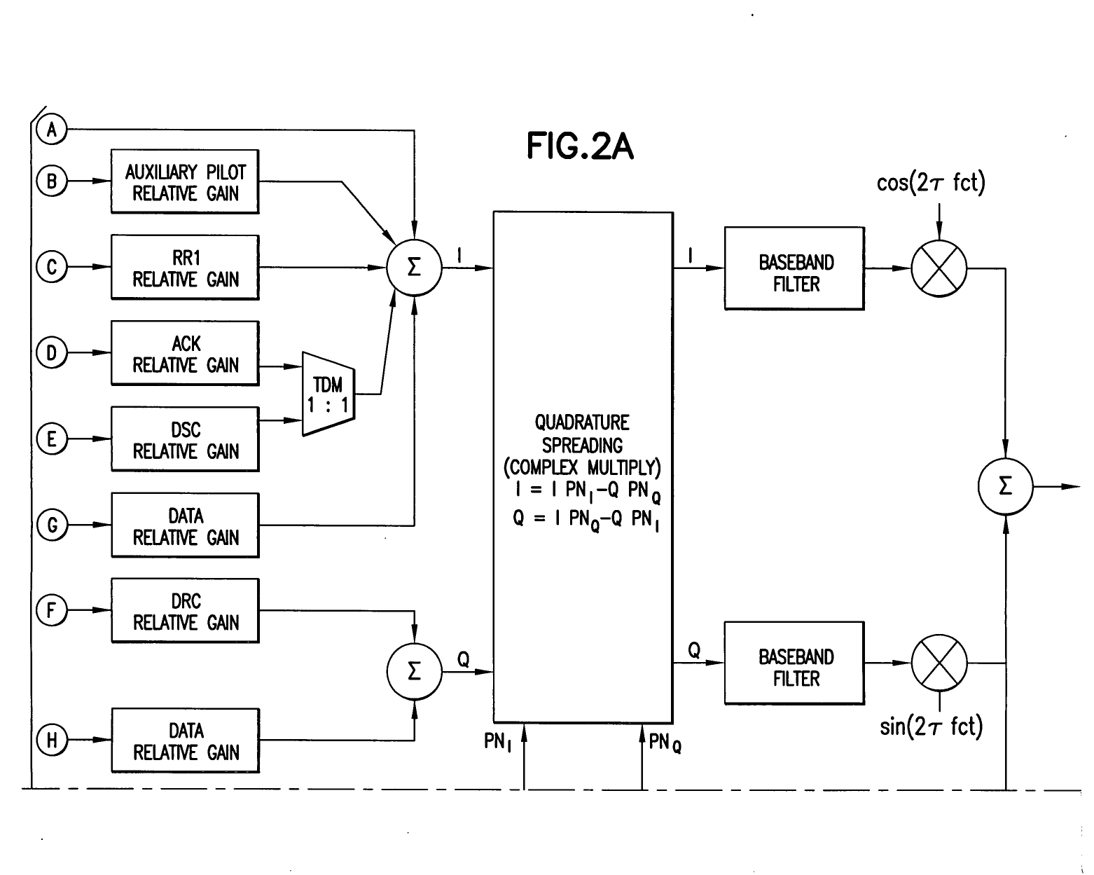

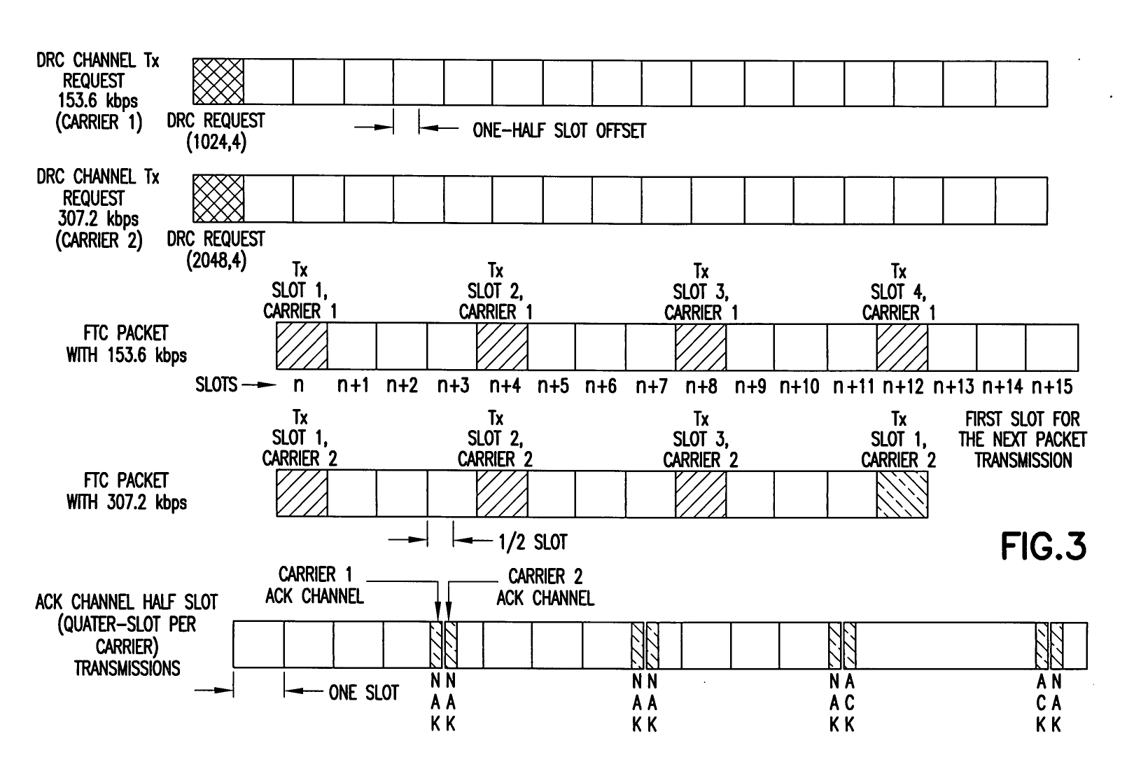

### DETAILED DESCRIPTION

With reference to FIG. 5, there is illustrated an exemplary embodiment of an ACK feedback mechanism for Multi-Carrier DO of the invention. As illustrated, the ACK feedback mechanism provides high flexibility for carrier allocations while also providing backwards-compatibility with existing approaches including, but not limited to, Nx EV-DO.

The ACK feedback mechanism for Multi-Carrier DO in accordance with exemplary embodiments of the invention uses a Code Division Multiplex (CDM) approach, wherein a plurality of FL channels can be ACKed, and where each ACK channel is assigned a separate Walsh code that is applied on a per ACK channel basis after ACK signal mapping and sequence repetition. The ACK channels are then combined and spread using a W³²₁₂ from a length 32 Walsh code.

In the exemplary embodiment shown, the separate Walsh codes for each ACK channel are selected from a length 16 Walsh code (W¹⁶₀-W¹⁶₁₅), the ACK signal mapping is as follows: (ACK=+1, NAK-1, OFF=0), and the sequence repetition is 2×.

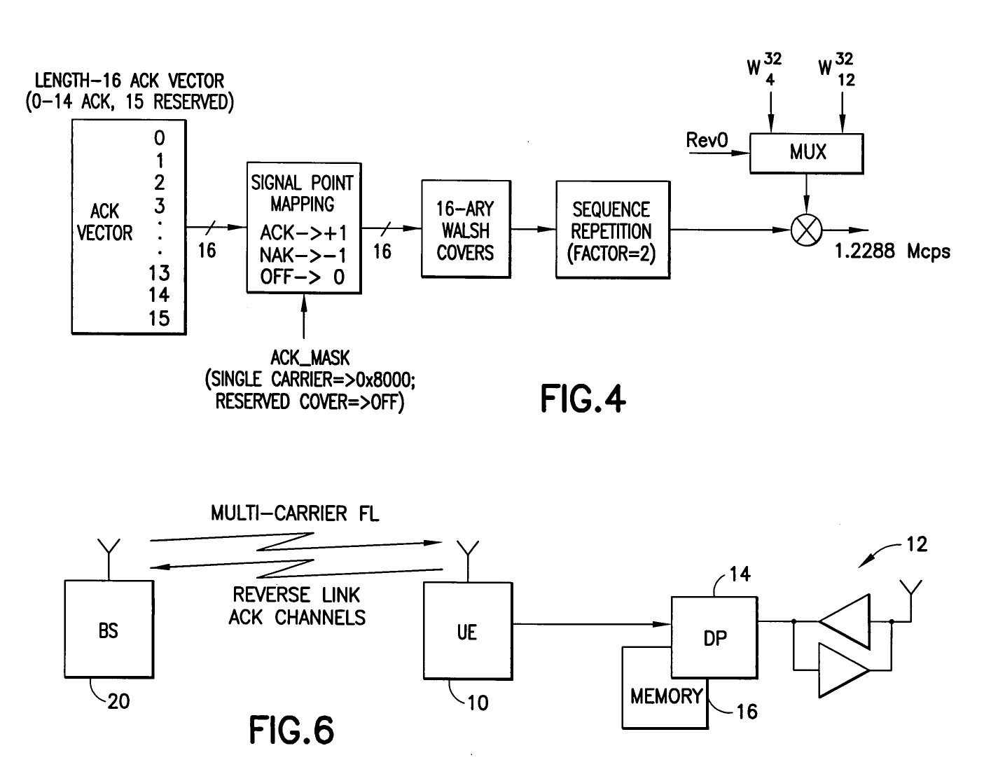

As noted, the exemplary embodiment shown in FIG. 5 provides a plurality (e.g., up to 16) of ACK signal mapping blocks 1, a corresponding plurality of repetition (2×) blocks 2, and a corresponding plurality of multiplication blocks 3 wherein individual ones of the length 16 Walsh codes (W¹⁶₀-W¹⁶₁₅) are applied on a per ACK channel basis to the signal mapped and repeated ACK channel signals (one bit per forward link carrier). Outputs of the multiplication blocks 3 are combined at node 4, and the resulting combined signal is applied to multiplier block 5 where they are spread using only a W³²₁₂ code from a length 32 Walsh code. Note that this differs from the approach in FIG. 4, which instead uses Walsh 32-4 and Walsh 32-12 multiplexing. The embodiment of FIG. 5 thus maintains full backwards-compatibility, and also provides a smooth carrier de-assignment to a single carrier, as the reverse A uses only Walsh 32-12.

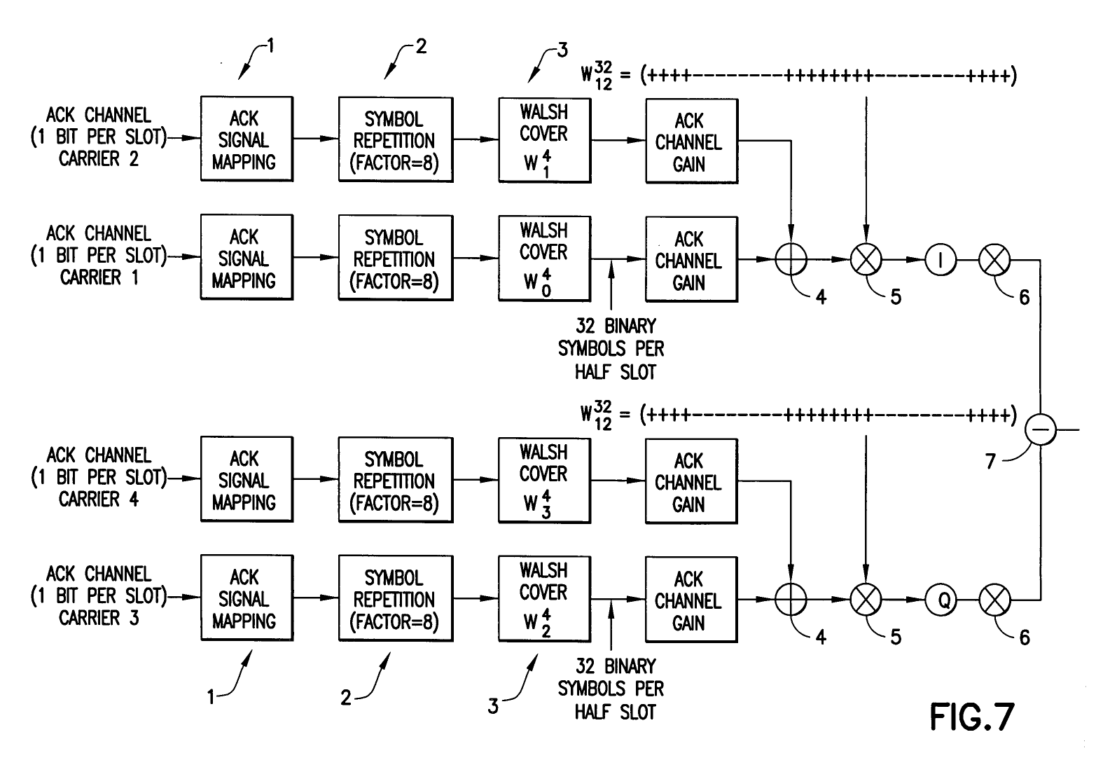

With reference to FIG. 7, there is illustrated another exemplary embodiment of the invention. As illustrated, four forward CDMA channels, each associated with an ACK channel for a single carrier, are combined to produce an output over one reverse CDMA channel. The embodiment shown provides four ACK signal mapping blocks 1, a corresponding plurality of repetition (8×) blocks 2, and a corresponding plurality of multiplication blocks 3 wherein individual ones of the length 4 Walsh codes (W⁴₀-W⁴₃) are applied on a per ACK channel basis to the signal mapped and repeated ACK channel signals (one bit per slot per forward link carrier). Two each of the outputs of the multiplication blocks 3 are combined at nodes 4, and the resulting two combined signals are applied to multiplier blocks 5 where they are each spread using only a W³²₁₂ code from a length 32 Walsh code to produce an in-phase output and a quadrature output. The in-phase output and quadrature output are each mixed via a process of frequency multiplication at nodes 6 with the resulting quadrature output signal being subtracted from the resulting in-phase output signal at node 7. As before with reference to the previous exemplary embodiment, the embodiment of FIG. 7 maintains full backwards-compatibility with Nx EV-DO

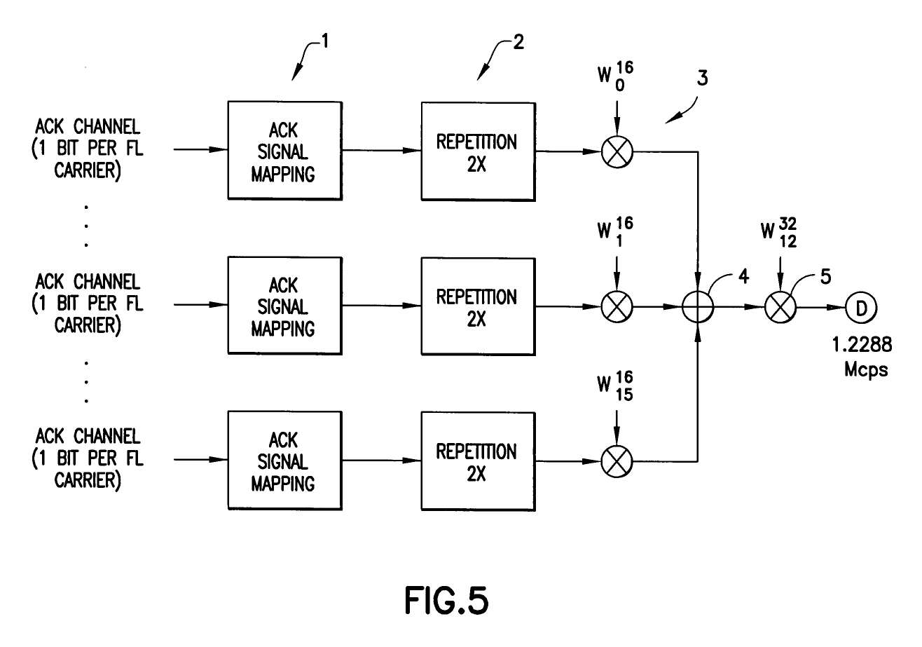

FIG. 6 shows user equipment (UE) 10 that is constructed to include the reverse ACK channel functionality shown in FIGS. 5 and 7 when receiving multiple forward link carriers (e.g., from 2 to 16) from a BS 20, and that provides a single reverse link carrier that includes the CDM ACK channels as described herein. UE 10 includes a suitable wireless transceiver 12 coupled to a data processor (DP) 14 that in turn includes or is coupled to a volatile and/or non-volatile memory 16. DP 14 can be an integrated circuit operative on a computer chip. The memory 16 stores program code that is executable by the DP 14 including program code that is provided to implement the signal processing aspects of this invention.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by a data processor of the UE 10, or by hardware, or by a combination of software and hardware. Further in this regard it should be noted that the various blocks shown in FIGS. 5 and 7 may represent program steps, or interconnected logic circuits, blocks and functions, or a combination of program steps and logic circuits, blocks and functions.

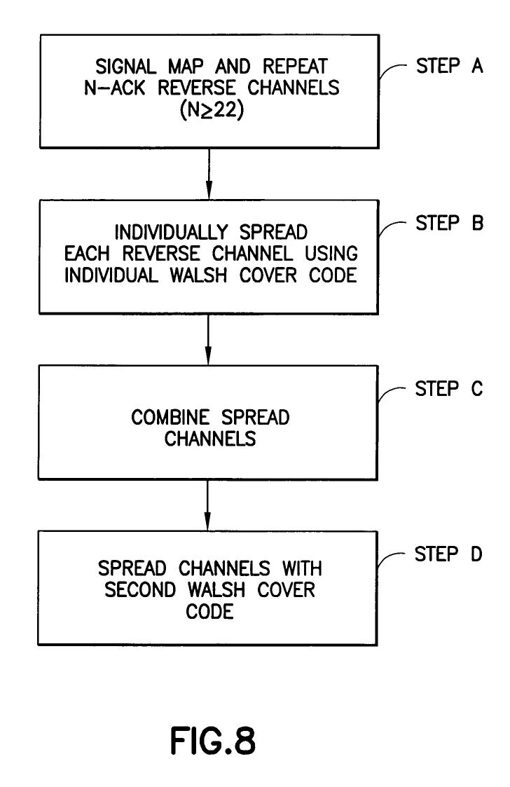

With reference to FIG. 8, there is illustrated an exemplary method of the invention. At step A, N ACK reverse channels (where N≧2) that correspond to N forward multi-carrier channels are individually signal mapped and repeated. At step B, the signal mapped and repeated channels are individually spread using an individual Walsh cover code. At step C, a plurality of the spread channels are combined and, at step D, are spread with a second Walsh cover code. In some embodiments N may equal 1, providing backwards compatibility with 1×-DO systems. In a non-limiting example of this invention the individual Walsh cover codes are selected from a length 16 Walsh code (W¹⁶₀-W¹⁶₁₅), and the second Walsh cover code is selected from a length 32 Walsh code (W³²₁₂). In another non-limiting example of the invention, Walsh cover codes are selected from a length 4 Walsh code (W⁴₀-W⁴₃), and the second Walsh cover code is selected from a length 32 Walsh code (W³²₁₂).

The ACK feedback mechanism for Multi-Carrier DO in accordance with the exemplary embodiments of the invention provides flexibility for dynamic operation with multiple FL channels, and furthermore is backwards compatible with earlier ACK feedback approaches.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is clamed is:

1. A method comprising:
generating a plurality of ACK channels;
spreading each of said plurality of ACK channels with a separate one of a plurality of Walsh cover codes;
combining each of said plurality of ACK channels; and
applying a Walsh cover code to said combined plurality of ACK channels.

2. The method of claim 1 wherein each of said plurality of ACK channels comprises a reverse ACK channel.

3. The method of claim 1 wherein generating comprises individually signal mapping and repeating said plurality of ACK channels.

4. The method of claim 1 wherein said plurality of ACK channels are combined to form a single output.

5. The method of claim 1 wherein said combining comprises:
combining a first plurality of said plurality of ACK channels to form an in-phase output;
combining a second plurality of said plurality of ACK channels to form a quadrature output; and
combining said in-phase output and said quadrature output to form a single output.

6. The method of claim 1 wherein each of said plurality of Walsh cover codes comprises a length 16 Walsh code.

7. The method of claim 1 wherein each of said plurality of Walsh cover codes comprises a length 4 Walsh code.

8. The method of claim 1 wherein said Walsh cover code comprises a length 32 Walsh code.

9. A method comprising:
establishing a plurality of ACK channels each corresponding to a separate forward link channel;
individually signal mapping and repeating said plurality of ACK channels;
spreading each of said plurality of ACK channels with a separate one of a plurality of Walsh cover codes;
combining each of said plurality of ACK channels; and
applying a Walsh cover code to said combined plurality of ACK channels.

10. The method of claim 9 wherein each of said plurality of ACK channels comprises a reverse ACK channel.

11. The method of claim 9 wherein said plurality of ACK channels are combined to form a single output.

12. The method of claim 9 wherein said combining comprises:
combining a first plurality of said plurality of ACK channels to form an in-phase output;
combining a second plurality of said plurality of ACK channels to form a quadrature output; and
combining said in-phase output and said quadrature output to form a single output.

13. The method of claim 9 wherein each of said plurality of Walsh cover codes comprises a length 16 Walsh code.

14. The method of claim 9 wherein each of said plurality of Walsh cover codes comprises a length 4 Walsh code.

15. The method of claim 9 wherein said Walsh cover code comprises a length 32 Walsh code.

16. A mobile terminal comprising:
a transceiver;
a processor coupled to the transceiver; and
a memory coupled to the processor for storing a set of instructions, executable by the processor, for establishing a plurality of ACK channels each corresponding to a separate forward link channel, individually signal mapping and repeating said plurality of ACK channels, spreading each of said plurality of ACK channels with a separate one of a plurality of Walsh cover codes, combining each of said plurality of ACK channels, and applying a Walsh cover code to said combined plurality of ACK channels.

17. The mobile station of claim 16 wherein each of said plurality of ACK channels comprises a reverse ACK channel.

18. The mobile terminal of claim 16 wherein said plurality of ACK channels are combined to form a single output.

19. The mobile terminal of claim 16 wherein each of said plurality of Walsh cover codes comprises a length 16 Walsh code.

20. The mobile terminal of claim 16 wherein each of said plurality of Walsh cover codes comprises a length 4 Walsh code.

21. The mobile terminal of claim 16 wherein said Walsh cover code comprises a length 32 Walsh code.

22. The mobile terminal of claim 16, wherein a first plurality of said plurality of ACK channels is combined to form an in-phase output, a second plurality of said plurality of ACK channels is combined to form a quadrature output, and said in-phase output and said quadrature output are combined to form a single output.

23. A program of machine-readable instructions, tangibly embodied on an information bearing medium and executable by a digital data processor, to perform actions comprising:
generating a plurality of ACK channels;
spreading each of said plurality of ACK channels with a separate one of a plurality of Walsh cover codes;
combining each of said plurality of ACK channels; and
applying a Walsh cover code to said combined plurality of ACK channels.

24. The program of claim 23 wherein each of said plurality of ACK channels comprises a reverse ACK channel.

25. The program of claim 23 wherein said plurality of ACK channels are combined to form a single output.

26. The program of claim 23 wherein said combining comprises:
combining a first plurality of said plurality of ACK channels to form an in-phase output;
combining a second plurality of said plurality of ACK channels to form a quadrature output; and
combining said in-phase output and said quadrature output to form a single output.

27. The program of claim 23 wherein each of said plurality of Walsh cover codes comprises a length 16 Walsh code.

28. The program of claim 23 wherein each of said plurality of Walsh cover codes comprises a length 4 Walsh code.

29. The program of claim 23 wherein said Walsh cover code comprises a length 32 Walsh code.

30. A network element comprising:
a wireless transceiver;
a processor coupled to the wireless transceiver; and
a memory coupled to the processor for storing a set of instructions, executable by the processor, for establishing a plurality of ACK channels each corresponding to a separate forward link channel, individually signal mapping and repeating said plurality of ACK channels, spreading each of said plurality of ACK channels with a separate one of a plurality of Walsh cover codes, combining each of said plurality of ACK channels, and applying a Walsh cover code to said combined plurality of ACK channels.

31. A device comprising:
means for generating a plurality of ACK channels;
means for spreading each of said plurality of ACK channels with a separate one of a plurality of Walsh cover codes;
means for combining each of said plurality of ACK channels; and
means for applying a Walsh cover code to said combined plurality of ACK channels.

32. An integrated circuit comprising:
means for generating a plurality of ACK channels;
means for spreading each of said plurality of ACK channels with a separate one of a plurality of Walsh cover codes;
means for combining each of said plurality of ACK channels; and
means for applying a Walsh cover code to said combined plurality of ACK channels.
